(19) United States
(12) Patent Application Publication
(10) Pub. No.: US 2014/0333424 A1
(43) Pub. Date: Nov. 13, 2014

(54) MONITORING APPARATUS FOR VEHICLE AND METHOD FOR MONITORING VEHICLE

(71) Applicant: HON HAI PRECISION INDUSTRY CO., LTD., New Taipei (TW)

(72) Inventors: YI-MING CHANG, New Taipei (TW); PENG-ZHENG YANG, New Taipei (TW); TENG-SHENG YU, New Taipei (TW)

(73) Assignee: HON HAI PRECISION INDUSTRY CO., LTD., New Taipei (TW)

(21) Appl. No.: 14/272,509

(22) Filed: May 8, 2014

(30) Foreign Application Priority Data
May 10, 2013 (TW) 102116799

(51) Int. Cl. B60R 25/30; B60R 25/104

(52) U.S. Cl. CPC B60R 25/30; B60R 25/104; B60R 2025/1013
USPC 340/426.22

(57) ABSTRACT

Method for monitoring a vehicle comprises sensing status changes of the vehicle in 3D space. The situations of the vehicle are identified. The numbers of times of each situations of the vehicle is counted during status changes. A threat of the vehicle is determined according to the identified situations, the counted times of each situation, and parameters stored in a storage unit. An alarm mode associated with the determined threat is triggered.

### FIELD

The present disclosure relates to a monitoring apparatus for a vehicle, and a method for monitoring a vehicle.

### BACKGROUND

Generally, a vehicle has the risk of being damaged or stolen when the vehicle is left unattended.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a diagrammatic view of an embodiment of a monitoring apparatus.

FIG. 2 is a flowchart of a method for monitoring a vehicle.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

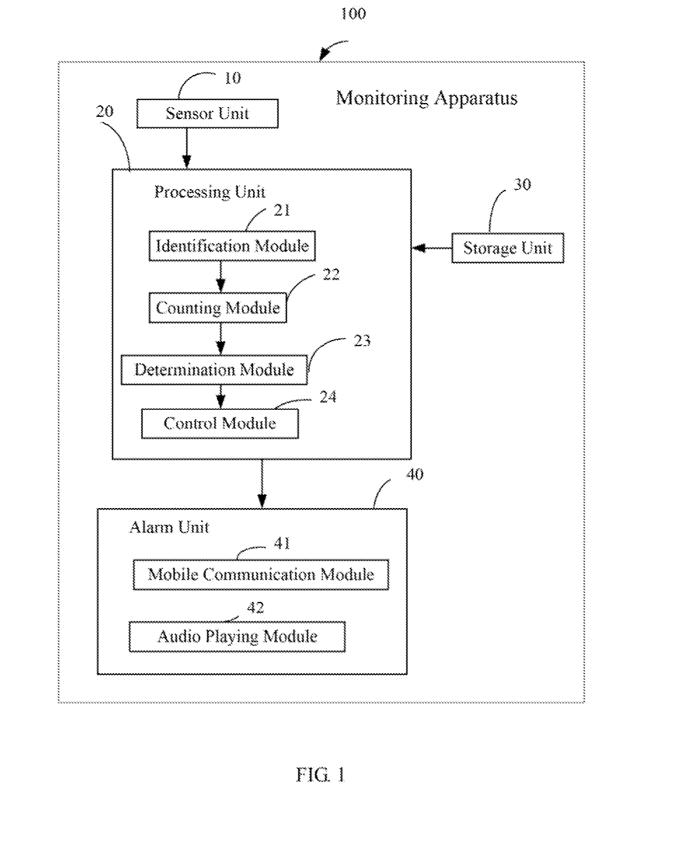

FIG. 1 illustrates a monitoring apparatus 100. The monitoring apparatus 100 is equipped on a vehicle and can include a sensor unit 10, a processing unit 20, a storage unit 30, and an alert unit 40.

The sensor unit 10 senses status changes of a vehicle in 3D space. In at least one embodiment, the sensor unit 10 senses status changes of the vehicle along an X-axis, a Y-axis, and a Z-axis in 3D space In the embodiment, the sensor unit 10 can include a position sensor, an acceleration sensor, and a force sensor. The position sensor senses a position of the vehicle in 3D space. The acceleration sensor senses an acceleration of the vehicle. The force sensor senses an external force acting on the vehicle.

The processing unit 20 can include an identification module 21, a counting module 22, a determination module 23, and a control module 24.

The identification module 21 identifies situations of the vehicle according to the status changes sensed by the sensor unit 10. In the embodiment, the situations of the vehicle include changes of position of the vehicle in 3D space, changes of external forces acting on the vehicle, rollover motions of the vehicle, shaking of the vehicle, and the like.

The count module 22 counts how many times each situation identified by the situation identifying module 21 occurs during a status change.

The storage unit 30 stores parameters to define threats that can occur to the vehicle. For example, parameters of each threat include one or more particular situations, and a probability that each particular situation will occur. The particular situation may be a change of position of the vehicle in 3D space, a change of external forces acting on the vehicle, a rollover motion of the vehicle, a shaking of the vehicle. In the embodiment, the threats that can occur to the vehicle can include theft, collision, towing, and overturning. For example, parameters of theft include three identifiable situations: shaking of the vehicle, blunt external forces on the vehicle, and sudden changes in position of the vehicle in 3D space. The probability of the vehicle shaking is 50 percent, the probability of a blunt external force on the vehicle is 25 percent, and the probability of a sudden change in 3D space of the vehicle is 25 percent. In an alternative embodiment, parameters to define each threat are defined by an owner of the vehicle or predefined by a manufacturer of the apparatus 10.

The determination module 23 determines the threat that is currently occurring to the vehicle according to the status changes of the vehicle based on the identified situations, a counted number of times of each of the identified situations, and stored parameters. In the embodiment, the determination module 23 calculates a probability that each threat may be currently occurring to the vehicle. The determination module 23 determines that the threat with the highest calculated probability is the threat that is currently occurring to the vehicle.

The storage unit 30 stores alarm modes associated with each kind of threat. In the embodiment, the alarm modes of each kind of threat include an alarm message or an alarm sound. In an alternative embodiment, the predefined alarm modes include both an alarm message and an alarm sound. For example, when the threat occurring to the vehicle is theft, the alarm message is “your car is being stolen,” and the alarm sound is a loud noise broadcast from the vehicle.

The control module 24 controls the alarm unit 40 to trigger the alarm mode according to the determined threat. In at least one embodiment, the alarm unit 40 includes a mobile communication module 41 and an audio playing module 42. The mobile communication module 41 is triggered to send out the alarm message associated with the identified threat to the owner of the vehicle to inform the owner of the threat. The audio playing module 42 is triggered to play the alarm sound associated with the threat to attract people's attention to the vehicle.

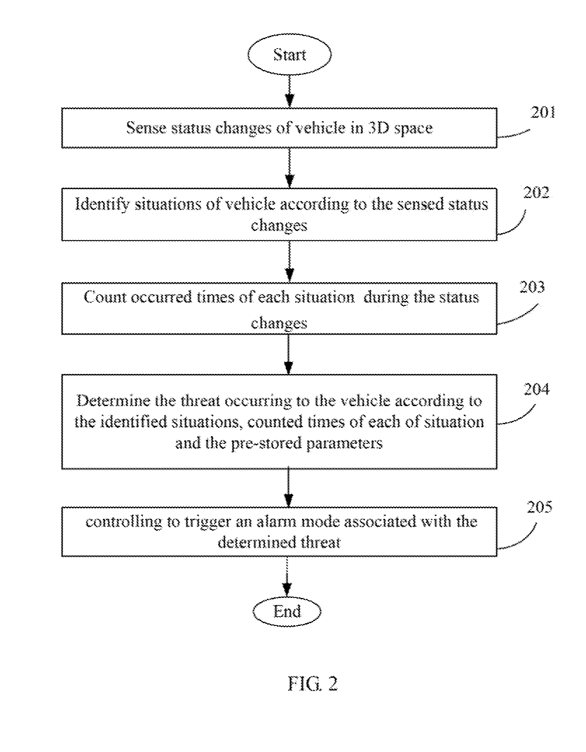

FIG. 2 illustrates a method for monitoring a vehicle. The method includes steps, each of which is related to various component of the safety monitoring apparatus.

In block 201, the sensor unit senses status changes of a vehicle in 3D space.

In block 202, the identification module identifies situations of the vehicle according to the sensed status changes.

In block 203, the count module counts the number of times each situation occurs during a status change.

In block 204, the determination module determines the threat currently occurring to the vehicle according to the status change of the vehicle based on the identified situations, counted times of each situation, and the pre-stored parameters. The security accidents of the vehicle that can occur to the vehicle include theft, collision, towing, and overturning.

In block 205, the control module 24 controls the alarm unit 40 to trigger an alarm mode according to the determined security accident. In the embodiment, the mobile communication module 41 is triggered to send an alarm message to the owner of the vehicle, and/or an audio playing module 42 is triggered to broadcast an alarm sound.

The apparatus for vehicle security surveillance provided by the present disclosure senses the status changes of the vehicle in 3D space, identifies situations of the vehicle according to the sensed status changes, counts the number of times each situation occurs during the status change, determines the security accident currently occurring to the vehicle, and triggers an alarm mode associated with the determined threat. Thus, the owner of the vehicle can be notified promptly of the threat of the vehicle.

Although the present disclosure has been described in considerable detail with reference to certain preferred embodiments thereof, the disclosure is not for limiting the scope of the disclosure. Persons having ordinary skill in the art may make various modifications and changes without departing from the scope of the disclosure. Therefore, the scope of the appended claims should not be limited to the description of the preferred embodiments described above.

What is claimed is:

1. A monitoring apparatus for a vehicle, comprising:
a sensor unit for sensing status changes of vehicle in 3D space;
a storage unit for storing parameters to define each of threats that are possible to occur to the vehicle;
an alarm unit; and
a processing unit comprising
an identification module for identifying situations of the vehicle according to the sensed status changes;
a counting module for counting a number of times when each of identified situation occurs during status changes;
a determined module for determining a threat occurring to the vehicle according to the identified situations, the counted times of the identified situations and the stored parameters;
a control module for controlling the alarm unit to trigger an alarm mode associated with the determined threat.

2. The monitoring apparatus for a vehicle as described in claim 1, wherein the parameters to define each threat that is possible to occur to the vehicle comprise one or more identified situations and a probability that each identified situation will occur.

3. The monitoring apparatus for a vehicle as described in claim 2, wherein the determination module calculates a probability that each threat may be currently occurring to the vehicle.

4. The monitoring apparatus for a vehicle as described in claim 3, wherein the determination module determines the threat occurring to the vehicle according to the calculated probability.

5. The monitoring apparatus for a vehicle as described in claim 4, wherein the threat occurring to the vehicle is selected from the group consisted of theft, collision, towing and overturning.

6. The safety monitoring apparatus for vehicle as described in claim 5, wherein the identifiable situations of the vehicle comprise changes of position of the vehicle in 3D space, changes of external forces acting on the vehicle, rollover motions of the vehicle, and shaking of the vehicle.

7. The monitoring apparatus for a vehicle as described in claim 6, wherein the sensor unit comprise a position sensor, an acceleration sensor, and a force sensor.

8. The monitoring apparatus for a vehicle as described in claim 5, wherein the alarm mode associated with the determination comprise an alarm message and an alarm sound.

9. The monitoring apparatus for a vehicle as described in claim 8, wherein the alarm unit comprises a mobile communication module and an audio playing module, the control unit controls the mobile communication module to send the alarm message associated with a threat to an owner of the vehicle, and controls the audio playing module to broadcast the alarm sound associated with a threat.

10. A method for monitoring a vehicle, comprising:
sensing status changes of vehicle in a 3D space;
identifying situations of the vehicle according to the sensed status changes;
counting a number of times when each of identified situation occurs during status changes;
determining a threat occurring to the vehicle according to the identified situations, the counted times of the identified situations and the stored parameters defining each of threats that are possible to occur to the vehicle;
controlling to trigger an alarm mode associated with the determined threat.

11. The method as described in claim 10, wherein the step determining comprises sub-steps:
calculating a probability that each threat may be currently occurring to the vehicle; and
determining the threat occurring to the vehicle according to the calculated probability.

12. The method as described in claim 11, wherein the situations of the vehicle are selected from the group consisting of changes of position of the vehicle in 3D space, changes of external force acting on the vehicle, rollover motions of the vehicle, shaking of the vehicle and.

13. The method as described in claim 12, wherein the threat occurring to the vehicle is selected from the group consisted of theft, collision, towing and overturning.

14. The method as described in claim 13, wherein the controlling is controlling to broadcast an alarm sound associated with the determined threat.

15. The method as described in claim 13, wherein the controlling is controlling to send an alarm message to an owner of the vehicle.
